(19) United States
(12) Patent Application Publication
(10) Pub. No.: US 2021/0061102 A1
(43) Pub. Date: Mar. 4, 2021

(54) OPERATION RESTRICTION CONTROL DEVICE AND OPERATION RESTRICTION CONTROL METHOD

(71) Applicant: MITSUBISHI ELECTRIC CORPORATION, Tokyo (JP)

(72) Inventors: Atsushi MAEDA, Tokyo (JP); Shin KATO, Tokyo (JP); Takumi TAKEI, Tokyo (JP); Naoya BABA, Tokyo (JP); Shiori ITO, Tokyo (JP); Takayoshi CHIKURI, Tokyo (JP)

(73) Assignee: MITSUBISHI ELECTRIC CORPORATION, Tokyo (JP)

(21) Appl. No.: 16/964,860

(22) PCT Filed: Feb. 22, 2018
(86) PCT No.: PCT/JP2018/006533

§ 371 Date: Jul. 24, 2020

(51) Int. Cl. B60K 35/00; G10L 15/22

(52) U.S. Cl. CPC B60K 35/00; G10L 15/22; G10L 2015/223; B60K 2370/148; B60K 2370/52; B60K 2370/152; B60K 2370/149; B60K 2370/40; B60K 2370/143

(57) ABSTRACT

An operation restriction control device includes processing circuitry configured to set restriction on the manual operation input to a valid state in a case where a vehicle is traveling, set the restriction on the manual operation input to an invalid state when a voice command corresponding to release of the restriction on the manual operation input is input to the first operation input device by a passenger in the vehicle in a state where the restriction on the manual operation input is set to a valid state, and set the restriction on the manual operation input to a valid state when a duration during which a line of sight of a driver of the vehicle is directed to the in-vehicle information device has exceeded a first reference time in a state where the restriction on the manual operation input is set to an invalid state.

### TECHNICAL FIELD

The present invention relates to an operation restriction control device and an operation restriction control method.

### BACKGROUND ART

Conventionally, an in-vehicle information device operable by an operation input device (hereinafter, referred to as “first operation input device”) for receiving operation input by voice (hereinafter, referred to as “voice operation input”) and an operation input device (hereinafter, referred to as “second operation input device”) for receiving operation input manually (hereinafter, referred to as “manual operation input”) have been developed.

In addition, a function of determining whether or not a vehicle is traveling, and restricting manual operation input when it is determined that the vehicle is traveling has been developed. As a result, it is possible to suppress manual operation input by a driver while a vehicle is traveling.

Furthermore, a function of determining, when predetermined voice is input to the first operation input device in a state where manual operation input is restricted, whether an utterer of the predetermined voice is a driver or a passenger, and releasing the restriction on manual operation input when it is determined that the utterer of the predetermined voice is the passenger has been developed. As a result, a passenger can perform manual operation input, and operability of an in-vehicle information device can be improved (for example, see Patent Literature 1).

### CITATION LIST

### Patent Literatures

Patent Literature 1: JP 2012-78497 A

### SUMMARY OF INVENTION

### Technical Problem

In a conventional in-vehicle information device, when predetermined voice is uttered by a passenger, restriction on manual operation input is released, and the passenger can manually operate the in-vehicle information device. However, at this time, a driver can also manually operate the in-vehicle information device. For this reason, a purpose of a function of restricting manual operation input, that is, a purpose of suppressing manual operation input by a driver while a vehicle is traveling is lost disadvantageously.

The present invention has been achieved in order to solve the above-described problem, and an object of the present invention is to allow a passenger to perform manual operation input when predetermined voice is uttered by the passenger, and at this time, to suppress manual operation input by a driver.

### Solution to Problem

The operation restriction control device of the present invention is an operation restriction control device for an in-vehicle information device operable by a first operation input device for receiving voice operation input and a second operation input device for receiving manual operation input, and includes: a first operation restriction control unit for setting restriction on manual operation input to a valid state in a case where a vehicle is traveling; a second operation restriction control unit for setting the restriction on manual operation input to an invalid state when a voice command corresponding to release of the restriction on manual operation input is input to the first operation input device by a passenger in the vehicle in a state where the first operation restriction control unit sets the restriction on manual operation input to a valid state; and a third operation restriction control unit for setting the restriction on manual operation input to a valid state when a duration during which the line of sight of a driver of the vehicle is directed to the in-vehicle information device has exceeded a first reference time in a state where the second operation restriction control unit sets the restriction on manual operation input to an invalid state.

### Advantageous Effects of Invention

According to the present disclosure, the above-described configuration allows a passenger to perform manual operation input when predetermined voice is uttered by the passenger and suppresses a driver's manual operation input.

### BRIEF DESCRIPTION OF DRAWINGS

FIG. 1 is a block diagram illustrating a main part of a control device including an operation restriction control device according to a first embodiment.

FIG. 2A is a block diagram illustrating a hardware configuration of the control device including the operation restriction control device according to the first embodiment. FIG. 2B is a block diagram illustrating another hardware configuration of the control device including the operation restriction control device according to the first embodiment.

FIG. 3A is a flowchart illustrating an operation of the control device including the operation restriction control device according to the first embodiment.

FIG. 3B is a flowchart illustrating another operation of the control device including the operation restriction control device according to the first embodiment.

FIG. 3C is a flowchart illustrating another operation of the control device including the operation restriction control device according to the first embodiment.

FIG. 3D is a flowchart illustrating another operation of the control device including the operation restriction control device according to the first embodiment.

FIG. 3E is a flowchart illustrating another operation of the control device including the operation restriction control device according to the first embodiment.

FIG. 3F is a flowchart illustrating another operation of the control device including the operation restriction control device according to the first embodiment.

FIG. 4 is a block diagram illustrating a main part of a control device including another operation restriction control device according to the first embodiment.

### DESCRIPTION OF EMBODIMENTS

Hereinafter, in order to describe the present invention in more detail, an embodiment for carrying out the present invention will be described with reference to the attached drawings.

### First Embodiment

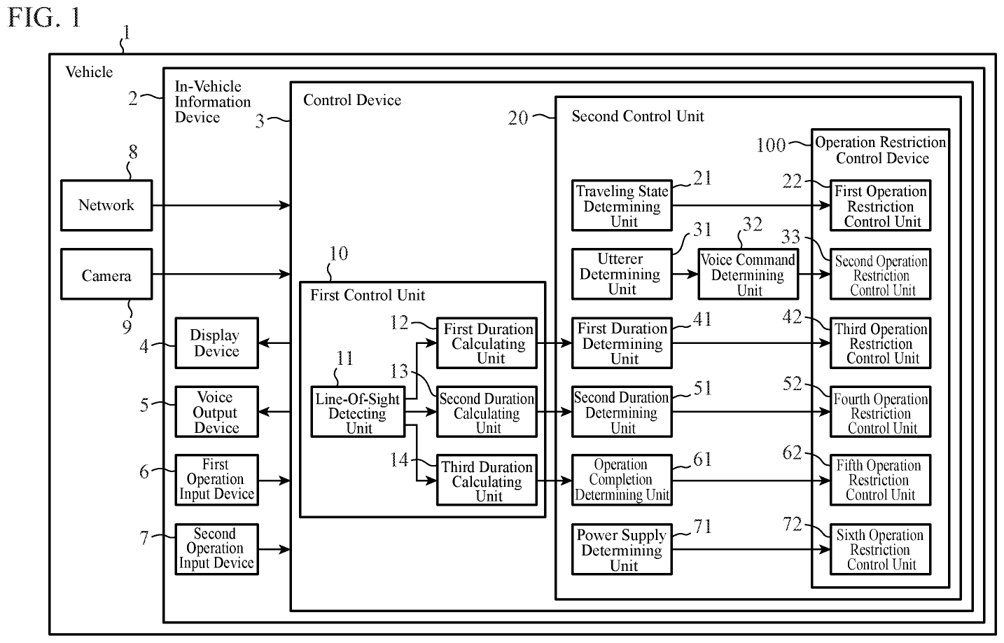

FIG. 1 is a block diagram illustrating a main part of a control device including an operation restriction control device according to a first embodiment. An operation restriction control device 100 according to the first embodiment will be described with reference to FIG. 1.

As illustrated in FIG. 1, an in-vehicle information device 2 is mounted on a vehicle 1. The in-vehicle information device 2 is disposed, for example, on a dashboard (more specifically, a center cluster) of the vehicle 1. The in-vehicle information device 2 includes a control device 3, a display device 4, a voice output device 5, a first operation input device 6, and a second operation input device 7.

The control device 3 has at least either various functions related to car navigation for the vehicle 1 (hereinafter, referred to as “navigation function”) or various functions related to car entertainment for the vehicle 1 (hereinafter, referred to as “entertainment function”). In FIG. 1, blocks corresponding to these functions are not illustrated. The content of processing by these functions is publicly known, and therefore detailed description thereof is omitted.

Examples of the navigation function include a function of calculating a current position of the vehicle 1, a function of setting a destination of the vehicle 1, a function of searching for a route from the calculated current position to the set destination, a function of selecting a route to be guided among the routes that have been found, and a function of guiding the selected route.

Examples of the entertainment function include a function of reproducing voice from radio broadcasting and a function of reproducing sound recorded on a recording medium such as a compact disc (CD) (hereinafter, collectively referred to as “sound reproducing function”). In addition, examples of the entertainment function include a function of reproducing video from television broadcasting and a function of reproducing video recorded on a recording medium such as a digital versatile disc (DVD) (hereinafter, collectively referred to as “video reproducing function”).

When the control device 3 has a navigation function, the display device 4 displays various images related to the navigation function. When the control device 3 has an entertainment function, the display device 4 displays various images related to the entertainment function. The display device 4 is constituted by, for example, a display such as a liquid crystal display (LCD) or an organic electro luminescence display (OLED).

When the control device 3 has a navigation function, the voice output device 5 outputs various types of voice related to a navigation function. When the control device 3 has an entertainment function, the voice output device 5 outputs various types of sound related to the entertainment function. The voice output device 5 is constituted by, for example, a speaker.

The first operation input device 6 receives operation input by voice, that is, voice operation input. The in-vehicle information device 2 is operable by the first operation input device 6. The first operation input device 6 is constituted by, for example, an array microphone. This array microphone is constituted by a plurality of microphones.

The second operation input device 7 receives operation input manually, that is, manual operation input. The in-vehicle information device 2 is operable by the second operation input device 7. The second operation input device 7 is constituted by, for example, a touch panel integrated with the display device 4. Alternatively, the second operation input device 7 is constituted by, for example, hardware keys disposed adjacent to the display device 4.

The in-vehicle information device 2 is connected to a network 8 in the vehicle 1. The network 8 is based on, for example, a controller area network (CAN) standard or a local interconnect network (LIN) standard. The control device 3 has a function of acquiring various signals in the vehicle 1 via the network 8. Specifically, for example, the control device 3 acquires a vehicle speed signal, a parking signal, an accessory signal (hereinafter, referred to as “ACC signal”), and an ignition signal (hereinafter, referred to as “IG signal”).

The vehicle 1 includes a camera 9 for capturing an image of a cabin interior. The camera 9 is constituted by, for example, a visible light camera or an infrared camera. The camera 9 is disposed in a front part of a cabin of the vehicle 1, and more specifically, is disposed at a position near the in-vehicle information device 2 (for example, on a center cluster). The camera 9 captures an image of an area including the face of a driver of the vehicle 1 (hereinafter, simply referred to as “driver”) and the face of a passenger seated on a front passenger seat of the vehicle 1 (hereinafter, referred to as “passenger on a front passenger seat”) from the front. The control device 3 has a function of acquiring image data indicating an image captured by the camera 9 from the camera 9.

Hereinafter, a main part of the control device 3 will be described.

A line-of-sight detecting unit 11 detects the line of sight of a driver and the line of sight of a passenger on the front passenger seat by executing image recognition processing on an image captured by the camera 9.

A first duration calculating unit 12 determines whether or not the line of sight of a driver is directed to the in-vehicle information device 2 using a result of the line-of-sight detection by the line-of-sight detecting unit 11. The first duration calculating unit 12 calculates a duration during which the line of sight of a driver is directed to the in-vehicle information device 2 (hereinafter, referred to as “first duration”) when it is determined that the line of sight of the driver is directed to the in-vehicle information device 2. The first duration calculating unit 12 outputs information indicating the calculated first duration to a first duration determining unit 41.

Note that when the line of sight of a driver is intermittently (that is, a plurality of times in a short time) directed to the in-vehicle information device 2, the first duration calculating unit 12 may calculate an accumulated value of these times as the first duration.

The second duration calculating unit 13 determines whether or not the line of sight of a driver is directed to the in-vehicle information device 2 using a result of the line-of-sight detection by the line-of-sight detecting unit 11. The second duration calculating unit 13 calculates a duration during which the line of sight of a driver is not directed to the in-vehicle information device 2 (hereinafter, referred to as “second duration”) when it is determined that the line of sight of the driver is not directed to the in-vehicle information device 2. The second duration calculating unit 13 outputs information indicating the calculated second duration to a second duration determining unit 51.

A third duration calculating unit 14 determines whether or not the line of sight of a passenger on the front passenger seat is directed to the in-vehicle information device 2 using a result of the line-of-sight detection by the line-of-sight detecting unit 11. The third duration calculating unit 14 calculates a duration during which the line of sight of a passenger on the front passenger seat is not directed to the in-vehicle information device 2 (hereinafter, referred to as “third duration”) when it is determined that the line of sight of the passenger on the front passenger seat is not directed to the in-vehicle information device 2. The third duration calculating unit 14 outputs information indicating the calculated third duration to an operation completion determining unit 61.

The line-of-sight detecting unit 11, the first duration calculating unit 12, the second duration calculating unit 13, and the third duration calculating unit 14 constitute a first control unit 10.

A traveling state determining unit 21 determines whether or not the vehicle 1 is traveling using a vehicle speed signal, a parking signal, an IG signal, and the like.

The first operation restriction control unit 22 sets restriction on manual operation input to a valid state when the traveling state determining unit 21 determines that the vehicle 1 is traveling. Meanwhile, the first operation restriction control unit 22 sets the restriction on manual operation input to an invalid state when the traveling state determining unit 21 determines that the vehicle 1 is not traveling.

In a state where the restriction on manual operation input is set to an invalid state, when an operation is input by the second operation input device 7, the control device 3 executes control corresponding to the operation. That is, by setting the restriction on manual operation input to an invalid state, manual operation input to the in-vehicle information device 2 becomes valid. Meanwhile, in a state where the restriction on manual operation input is set to a valid state, when an operation is input by the second operation input device 7, the control device 3 does not execute control corresponding to the operation. That is, by setting the restriction on manual operation input to a valid state, manual operation input to the in-vehicle information device 2 becomes invalid.

Note that when an operation is input by the second operation input device 7 in a state where the restriction on manual operation input is set to a valid state, the control device 3 may cause the display device 4 to display a warning image indicating that the manual operation input is restricted. Alternatively, at this time, the control device 3 may cause the voice output device 5 to output warning voice indicating that the manual operation input is restricted.

An utterer determining unit 31 determines whether an utterer of a voice input (hereinafter, referred to as “input voice”) is a driver or a passenger on the front passenger seat when the voice is input to the first operation input device 6 in a state where the first operation restriction control unit 22 sets the manual operation input to an invalid state. In FIG. 1, a connection line between the first operation restriction control unit 22 and the utterer determining unit 31 is not illustrated.

For example, when the first operation input device 6 is constituted by an array microphone, the utterer determining unit 31 estimates an incoming direction of input voice to the first operation input device 6 by executing voice signal processing on output signals from a plurality of microphones. The utterer determining unit 31 determines whether the input voice is uttered in a driver's seat or uttered in a passenger seat on the basis of the estimated incoming direction. When it is determined that the input voice is uttered in the driver's seat, the utterer determining unit 31 determines that the utterer of the input voice is the driver. Meanwhile, when it is determined that the input voice is uttered in the passenger seat, the utterer determining unit 31 determines that the utterer of the input voice is the passenger on passenger seat.

A voice command determining unit 32 determines whether or not input voice is a voice command corresponding to release of restriction on manual operation input (hereinafter, referred to as “restriction release command”) when the utterer determining unit 31 determines that the utterer of the input voice is a passenger on passenger seat.

Specifically, for example, the voice command determining unit 32 determines whether or not a predetermined keyword (for example, a keyword of “unlock”) instructing release of the restriction on manual operation input is included in the input voice. When it is determined that the predetermined keyword is included in the input voice, the voice command determining unit 32 determines that the input voice is a restriction release command. Meanwhile, when the predetermined keyword is not included in the input voice, the voice command determining unit 32 determines that the input voice is not a restriction release command.

Alternatively, for example, the voice command determining unit 32 determines whether or not at least one keyword among a plurality of keywords used for operating the in-vehicle information device 2, that is, at least one keyword among a plurality of keywords that can be determined by the voice command determining unit 32 is included in the input voice. When it is determined that the at least one keyword is included in the input voice, the voice command determining unit 32 determines that the input voice is a restriction release command. Meanwhile, when it is determined that the at least one keyword is not included in the input voice, the voice command determining unit 32 determines that the input voice is not a restriction release command.

The second operation restriction control unit 33 sets the restriction on manual operation input to an invalid state when the voice command determining unit 32 determines that the input voice is a restriction release command. That is, the second operation restriction control unit 33 switches the restriction on manual operation input from a valid state to an invalid state when the restriction release command is input to the first operation input device 6 by a passenger on the front passenger seat in a state where the first operation restriction control unit 22 sets the restriction on manual operation input to a valid state.

The first duration determining unit 41 determines whether or not the first duration has exceeded a predetermined time (hereinafter, referred to as “first reference time”) using information output by the first duration calculating unit 12 in a state where the second operation restriction control unit 33 sets the restriction on manual operation input to an invalid state. As a result, the first duration determining unit 41 determines whether or not a driver is manually operating (or about to operate) the in-vehicle information device 2. The first reference time is set to, for example, a value of about several seconds. In FIG. 1, a connection line between the second operation restriction control unit 33 and the first duration determining unit 41 is not illustrated.

The third operation restriction control unit 42 sets the restriction on manual operation input to a valid state when the first duration determining unit 41 determines that the first duration has exceeded the first reference time. That is, the third operation restriction control unit 42 switches the restriction on manual operation input from an invalid state to a valid state when the first duration has exceeded the first reference time in a state where the second operation restriction control unit 33 sets the restriction on manual operation input to an invalid state.

The second duration determining unit 51 determines whether or not the second duration has exceeded a predetermined time (hereinafter, referred to as “second reference time”) using information output by the second duration calculating unit 13 in a state where the third operation restriction control unit 42 sets the restriction on manual operation input to a valid state. As a result, the second duration determining unit 51 determines whether or not a driver has stopped (or given up) manual operation of the in-vehicle information device 2. The second reference time is set to, for example, a value of about several seconds. In FIG. 1, a connection line between the third operation restriction control unit 42 and the second duration determining unit 51 is not illustrated.

A fourth operation restriction control unit 52 sets restriction on manual operation input to an invalid state when the second duration determining unit 51 determines that the second duration has exceeded the second reference time. That is, the fourth operation restriction control unit 52 switches the restriction on manual operation input from a valid state to an invalid state when the second duration has exceeded the second reference time in a state where the third operation restriction control unit 42 sets the restriction on manual operation input to a valid state.

The operation completion determining unit 61 determines whether or not the third duration has exceeded a predetermined time (hereinafter, referred to as “third reference time”) using information output by the third duration calculating unit 14 in a state where the second operation restriction control unit 33 sets the restriction on manual operation input to an invalid state. The operation completion determining unit 61 determines whether or not the third duration has exceeded the third reference time using information output by the third duration calculating unit 14 in a state where the fourth operation restriction control unit 52 sets the restriction on manual operation input to an invalid state. As a result, the operation completion determining unit 61 determines whether or not the operation of the in-vehicle information device 2 by a passenger on the front passenger seat has been completed. The third reference time is set to, for example, a value of about several seconds. In FIG. 1, a connection line between the second operation restriction control unit 33 and the operation completion determining unit 61 and a connection line between the fourth operation restriction control unit 52 and the operation completion determining unit 61 are not illustrated.

A fifth operation restriction control unit 62 sets restriction on manual operation input to a valid state when the operation completion determining unit 61 determines that the third duration has exceeded the third reference time. That is, the fifth operation restriction control unit 62 switches the restriction on manual operation input from an invalid state to a valid state when the operation of the in-vehicle information device 2 by a passenger on the front passenger seat has been completed in a state where the second operation restriction control unit 33 or the fourth operation restriction control unit 52 sets the restriction on manual operation input to an invalid state.

A power supply determining unit 71 determines whether or not an accessory power supply (hereinafter, referred to as “ACC power supply”) in the vehicle 1 has been turned off using an ACC signal or the like in a state where the second operation restriction control unit 33 sets restriction on manual operation input to an invalid state. The power supply determining unit 71 determines whether or not the ACC power supply has been turned off using an ACC signal or the like in a state where the fourth operation restriction control unit 52 sets the restriction on manual operation input to an invalid state. In FIG. 1, a connection line between the second operation restriction control unit 33 and the power supply determining unit 71 and a connection line between the fourth operation restriction control unit 52 and the power supply determining unit 71 are not illustrated.

A sixth operation restriction control unit 72 sets restriction on manual operation input to a valid state when the power supply determining unit 71 determines that the ACC power supply has been turned off. That is, the sixth operation restriction control unit 72 switches the restriction on manual operation input from an invalid state to a valid state when the ACC power supply has been turned off in a state where the second operation restriction control unit 33 or the fourth operation restriction control unit 52 sets the restriction on manual operation input to an invalid state.

The traveling state determining unit 21, the first operation restriction control unit 22, the utterer determining unit 31, the voice command determining unit 32, the second operation restriction control unit 33, the first duration determining unit 41, the third operation restriction control unit 42, the second duration determining unit 51, the fourth operation restriction control unit 52, the operation completion determining unit 61, the fifth operation restriction control unit 62, the power supply determining unit 71, and the sixth operation restriction control unit 72 constitute a second control unit 20.

The first operation restriction control unit 22, the second operation restriction control unit 33, the third operation restriction control unit 42, the fourth operation restriction control unit 52, the fifth operation restriction control unit 62, and the sixth operation restriction control unit 72 constitute a main part of the operation restriction control device 100. The first control unit 10 and the second control unit 20 constitute a main part of the control device 3.

Note that the control device 3 holds a restriction release command when the voice command determining unit 32 determines that input voice is the restriction release command. As a result, while a passenger on the front passenger seat is operating the in-vehicle information device 2, the restriction release command for the operation can be held. Thereafter, when the fifth operation restriction control unit 62 switches restriction on manual operation input from an invalid state to a valid state (that is, when the third duration has exceeded the third reference time), the control device 3 discards the held restriction release command. As a result, it is possible to discard an unnecessary restriction release command at a timing when the operation of the in-vehicle information device 2 by a passenger on the front passenger seat has been completed.

When the sixth operation restriction control unit 72 switches restriction on manual operation input from an invalid state to a valid state (that is, when the ACC power supply has been turned off), the control device 3 discards the held restriction release command. As a result, for example, even in a state where the third duration is not normally calculated due to an error in line-of-sight detection by the line-of-sight detecting unit 11 or the like, it is possible to discard the restriction release command at the timing when the ACC power supply has been turned off.

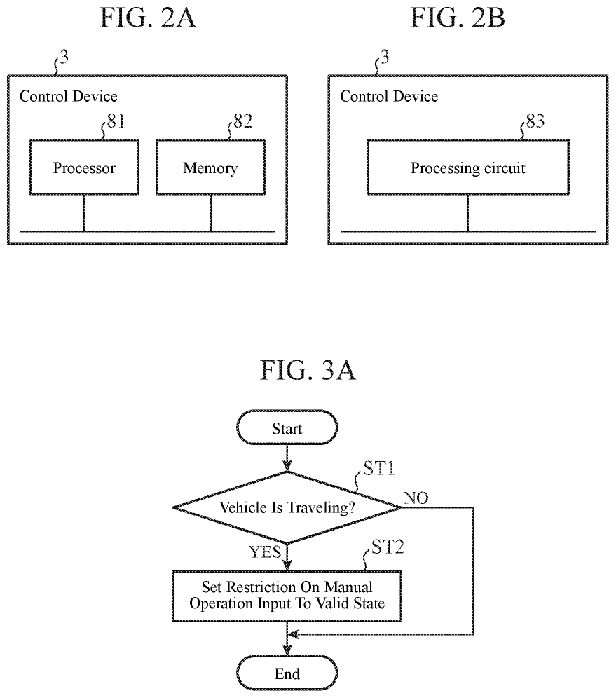

Next, a hardware configuration of a main part of the control device 3 will be described with reference to FIG. 2.

As illustrated in FIG. 2A, the control device 3 is constituted by a computer, and the computer includes a processor 81 and a memory 82. The memory 82 stores a program for causing the computer to function as the line-of-sight detecting unit 11, the first duration calculating unit 12, the second duration calculating unit 13, the third duration calculating unit 14, the traveling state determining unit 21, the first operation restriction control unit 22, the utterer determining unit 31, the voice command determining unit 32, the second operation restriction control unit 33, the first duration determining unit 41, the third operation restriction control unit 42, the second duration determining unit 51, the fourth operation restriction control unit 52, the operation completion determining unit 61, the fifth operation restriction control unit 62, the power supply determining unit 71, and the sixth operation restriction control unit 72. By reading and execution of the program stored in the memory 82 by the processor 81, functions of the line-of-sight detecting unit 11, the first duration calculating unit 12, the second duration calculating unit 13, the third duration calculating unit 14, the traveling state determining unit 21, the first operation restriction control unit 22, the utterer determining unit 31, the voice command determining unit 32, the second operation restriction control unit 33, the first duration determining unit 41, the third operation restriction control unit 42, the second duration determining unit 51, the fourth operation restriction control unit 52, the operation completion determining unit 61, the fifth operation restriction control unit 62, the power supply determining unit 71, and the sixth operation restriction control unit 72 are implemented.

The processor 81 uses, for example, a central processing unit (CPU), a graphics processing unit (GPU), a microprocessor, a microcontroller, or a digital signal processor (DSP). The memory 82 uses, for example, a semiconductor memory such as a random access memory (RAM), a read only memory (ROM), a flash memory, an erasable programmable read only memory (EPROM), or an electrically erasable programmable read-only memory (EEPROM), a magnetic disk, an optical disc, or a magneto-optical disk.

Alternatively, as illustrated in FIG. 2B, the functions of the line-of-sight detecting unit 11, the first duration calculating unit 12, the second duration calculating unit 13, the third duration calculating unit 14, the traveling state determining unit 21, the first operation restriction control unit 22, the utterer determining unit 31, the voice command determining unit 32, the second operation restriction control unit 33, the first duration determining unit 41, the third operation restriction control unit 42, the second duration determining unit 51, the fourth operation restriction control unit 52, the operation completion determining unit 61, the fifth operation restriction control unit 62, the power supply determining unit 71, and the sixth operation restriction control unit 72 may be implemented by a dedicated processing circuit 83. The processing circuit 83 uses, for example, an application specific integrated circuit (ASIC), a programmable logic device (PLD), a field-programmable gate array (FPGA), a system-on-a-chip (SoC), or a system large-scale integration (LSI).

Alternatively, the control device 3 may include the processor 81, the memory 82, and the processing circuit 83. In this case, some of the functions of the line-of-sight detecting unit 11, the first duration calculating unit 12, the second duration calculating unit 13, the third duration calculating unit 14, the traveling state determining unit 21, the first operation restriction control unit 22, the utterer determining unit 31, the voice command determining unit 32, the second operation restriction control unit 33, the first duration determining unit 41, the third operation restriction control unit 42, the second duration determining unit 51, the fourth operation restriction control unit 52, the operation completion determining unit 61, the fifth operation restriction control unit 62, the power supply determining unit 71, and the sixth operation restriction control unit 72 may be implemented by the processor 81 and the memory 82, and the other functions may be implemented by the processing circuit 83.

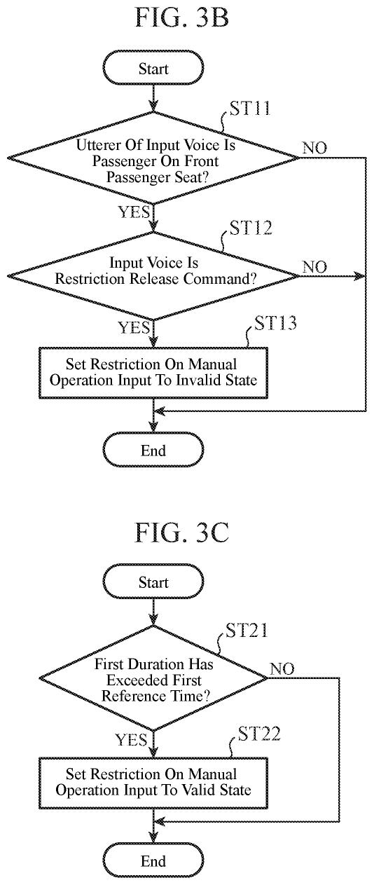

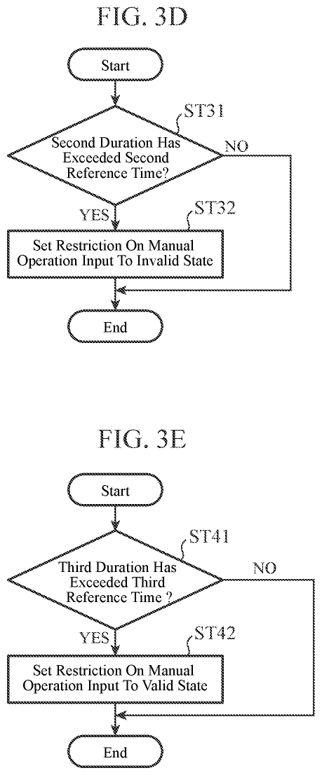

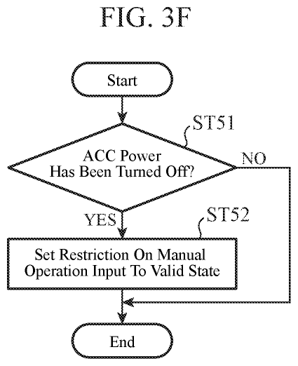

Next, an operation of the control device 3 will be described focusing on an operation of the second control unit 20 with reference to the flowchart of FIG. 3.

FIG. 3A illustrates operations of the traveling state determining unit 21 and the first operation restriction control unit 22. The processes in steps ST1 and ST2 illustrated in FIG. 3A are repeatedly executed, for example, at predetermined time intervals in a state where the power supply of the in-vehicle information device 2 is turned on.

First, in step ST1, the traveling state determining unit 21 determines whether or not the vehicle 1 is traveling. If it is determined that the vehicle 1 is traveling (“YES” in step ST1), in step ST2, the first operation restriction control unit 22 sets the restriction on manual operation input to a valid state.

Note that in FIG. 3A, a process executed if it is determined that the vehicle 1 is not traveling (“NO” in step ST1), that is, a process in which the first operation restriction control unit 22 sets restriction on manual operation input to an invalid state is not illustrated.

FIG. 3B illustrates operations of the utterer determining unit 31, the voice command determining unit 32, and the second operation restriction control unit 33. The processes in steps ST11 to ST13 illustrated in FIG. 3B are executed, for example, every time voice is input to the first operation input device 6 in a state where the first operation restriction control unit 22 sets restriction on manual operation input to a valid state.

First, in step ST11, the utterer determining unit 31 determines whether the utterer of input voice is a driver or a passenger on the front passenger seat. If it is determined that the utterer of the input voice is a passenger on the front passenger seat (“YES” in step ST11), in step ST12, the voice command determining unit 32 determines whether or not the input voice is a restriction release command. If it is determined that the input voice is the restriction release command (“YES” in step ST12), in step ST13, the second operation restriction control unit 33 sets restriction on manual operation input to an invalid state. That is, the second operation restriction control unit 33 switches the restriction on manual operation input from a valid state to an invalid state.

Note that a process executed if it is determined that the utterer of the input voice is a driver (“NO” in step ST11) and a process executed if the input voice is not the restriction release command (“NO” in step ST12) are not illustrated or described.

FIG. 3C illustrates operations of the first duration determining unit 41 and the third operation restriction control unit 42. The processes in steps ST21 and ST22 illustrated in FIG. 3C are repeatedly executed, for example, at predetermined time intervals in a state where the second operation restriction control unit 33 sets restriction on manual operation input to an invalid state.

First, in step ST21, the first duration determining unit 41 determines whether or not the first duration has exceeded the first reference time using information output by the first duration calculating unit 12. As a result, the first duration determining unit 41 determines whether or not a driver is manually operating (or about to operate) the in-vehicle information device 2.

If it is determined that the first duration has exceeded the first reference time (“YES” in step ST21), in step ST22, the third operation restriction control unit 42 sets restriction on manual operation input to a valid state. That is, the third operation restriction control unit 42 switches the restriction on manual operation input from an invalid state to a valid state.

FIG. 3D illustrates operations of the second duration determining unit 51 and the fourth operation restriction control unit 52. The processes in steps ST31 and ST32 illustrated in FIG. 3D are repeatedly executed, for example, at predetermined time intervals in a state where the third operation restriction control unit 42 sets restriction on manual operation input to a valid state.

First, in step ST31, the second duration determining unit 51 determines whether or not the second duration has exceeded the second reference time using information output by the second duration calculating unit 13. As a result, the second duration determining unit 51 determines whether or not a driver has stopped (or given up) manual operation of the in-vehicle information device 2.

If it is determined that the second duration has exceeded the second reference time (“YES” in step ST31), in step ST32, the fourth operation restriction control unit 52 sets restriction on manual operation input to an invalid state. That is, the fourth operation restriction control unit 52 switches the restriction on manual operation input from a valid state to an invalid state.

FIG. 3E illustrates operations of the operation completion determining unit 61 and the fifth operation restriction control unit 62. The processes in steps ST41 and ST42 illustrated in FIG. 3E are repeatedly executed, for example, at predetermined time intervals in a state where the second operation restriction control unit 33 sets restriction on manual operation input to an invalid state. The processes in steps ST41 and ST42 illustrated in FIG. 3E are repeatedly executed, for example, at predetermined time intervals in a state where the fourth operation restriction control unit 52 sets the restriction on manual operation input to an invalid state.

First, in step ST41, the operation completion determining unit 61 determines whether or not the third duration has exceeded the third reference time using information output by the third duration calculating unit 14. As a result, the operation completion determining unit 61 determines whether or not operation of the in-vehicle information device 2 by a passenger on the front passenger seat has been completed.

If it is determined that the third duration has exceeded the third reference time (“YES” in step ST41), in step ST42, the fifth operation restriction control unit 62 sets restriction on manual operation input to a valid state. That is, the fifth operation restriction control unit 62 switches the restriction on manual operation input from an invalid state to a valid state.

Note that when the fifth operation restriction control unit 62 switches the restriction on manual operation input from an invalid state to a valid state (that is, when it is determined to be “YES” in step ST41), the control device 3 discards the held restriction release command. As a result, it is possible to discard an unnecessary restriction release command at a timing when the operation of the in-vehicle information device 2 by a passenger on the front passenger seat has been completed.

FIG. 3F illustrates operations of the power supply determining unit 71 and the sixth operation restriction control unit 72. The processes in steps ST51 and ST52 illustrated in FIG. 3F are repeatedly executed, for example, at predetermined time intervals in a state where the second operation restriction control unit 33 sets the restriction on manual operation input to an invalid state. The processes in steps ST51 and ST52 illustrated in FIG. 3F are repeatedly executed, for example, at predetermined time intervals in a state where the fourth operation restriction control unit 52 sets the restriction on manual operation input to an invalid state.

First, in step ST51, the power supply determining unit 71 determines whether or not the ACC power supply has been turned off. If it is determined that the ACC power supply has been turned off (“YES” in step ST51), in step ST52, the sixth operation restriction control unit 72 sets restriction on manual operation input to a valid state. That is, the sixth operation restriction control unit 72 switches the restriction on manual operation input from an invalid state to a valid state.

Note that when the sixth operation restriction control unit 72 switches the restriction on manual operation input from an invalid state to a valid state (that is, when it is determined to be “YES” in step ST51), the control device 3 discards the held restriction release command. As a result, for example, even in a state where the third duration is not normally calculated due to an error in line-of-sight detection by the line-of-sight detecting unit 11 or the like, it is possible to discard the restriction release command at the timing when the ACC power supply has been turned off

Next, effects of the operation restriction control device 100 will be described.

A conventional operation restriction control device includes a function unit corresponding to the first operation restriction control unit 22 and a function unit corresponding to the second operation restriction control unit 33. However, the conventional operation restriction control device does not include a function unit corresponding to the third operation restriction control unit 42. For this reason, in a state where the function unit corresponding to the second operation restriction control unit 33 sets restriction on manual operation input to an invalid state, a passenger on the front passenger seat can manually operate an in-vehicle information device, but a driver can also manually operate the in-vehicle information device disadvantageously.

For example, in a navigation function, it is assumed that first, a current position of a vehicle is calculated, then a destination of the vehicle is set by a manual operation of a passenger on the front passenger seat (hereinafter, referred to as “first operation”), then a route from the calculated current position to the set destination is searched for, then a route to be guided among the routes that have been found is selected by a manual operation of the passenger on the front passenger seat (hereinafter, referred to as “second operation”), and then guidance of the selected route is started. In this case, manual operation input can be performed by a driver at a timing between the first operation and the second operation.

For example, in a voice reproducing function (more specifically, a function of reproducing voice recorded on a recording medium), it is assumed that first, one of a plurality of artists is selected by a manual operation of a passenger on the front passenger seat (hereafter, referred to as “third operation”), then any one of a plurality of music pieces of the selected artist is selected by a manual operation of the passenger on the front passenger seat (hereinafter, referred to as “fourth operation”), and then reproduction of the selected music piece starts. In this case, manual operation input can be performed by a driver at a timing between the third operation and the fourth operation.

Meanwhile, the operation restriction control device 100 according to the first embodiment includes the third operation restriction control unit 42. For this reason, when a driver is manually operating (or about to operate) the in-vehicle information device 2 in a state where the second operation restriction control unit 33 sets restriction on manual operation input to an invalid state, the restriction on manual operation input is switched from an invalid state to a valid state. As a result, the manual operation input becomes invalid, and therefore it is possible to suppress the manual operation input by a driver.

The operation restriction control device 100 according to the first embodiment includes the fourth operation restriction control unit 52. For this reason, when a driver has stopped (or given up) manual operation of the in-vehicle information device 2 in a state where the third operation restriction control unit 42 sets restriction on manual operation input to a valid state, the restriction on manual operation input is switched from a valid state to an invalid state. As a result, the manual operation input becomes valid, and therefore operability of the in-vehicle information device 2 by a passenger on the front passenger seat can be improved.

The operation restriction control device 100 according to the first embodiment includes the fifth operation restriction control unit 62. For this reason, restriction on manual operation input is switched from an invalid state to a valid state when operation of the in-vehicle information device 2 by a passenger on the front passenger seat has been completed in a state where the second operation restriction control unit 33 or the fourth operation restriction control unit 52 sets the restriction on manual operation input to a valid state. As a result, the manual operation input becomes invalid, and therefore it is possible to suppress the manual operation input by a driver.

In this way, the operation restriction control device 100 according to the first embodiment can achieve a balance between suppression of manual operation input by a driver and operability by a passenger on the front passenger seat.

The conventional operation restriction control device determines whether a user manually operating (or about to operate) an in-vehicle information device is a driver or a passenger on the front passenger seat by detecting a hand approaching direction with respect to the in-vehicle information device using a camera or a sensor disposed near the in-vehicle information device, and sets restriction on manual operation input to a valid state when the user is determined to be the driver (for example, see paragraph [0054] of Patent Literature 1 and the like).

Meanwhile, the operation restriction control device 100 according to the first embodiment uses a result of line-of-sight detection by the line-of-sight detecting unit 11 (more specifically, the second duration) for determining whether or not a driver is manually operating (or about to operate) the in-vehicle information device 2. As a result, the accuracy of the determination can be improved as compared to a configuration in which a detection result of a hand approaching direction is used for the determination. That is, this is because the accuracy of line-of-sight detection is usually higher than the accuracy of detection of a hand approaching direction in the technical field of image recognition processing at the time of filing the present application.

Note that the line-of-sight detecting unit 11 may include a first line-of-sight detecting unit (not illustrated) for detecting the line of sight of a driver and a second line-of-sight detecting unit (not illustrated) for detecting the line of sight of a passenger on the front passenger seat. In this case, the first duration calculating unit 12 may calculate the first duration using a result of the line-of-sight detection by the first line-of-sight detecting unit. The second duration calculating unit 13 may calculate the second duration using a result of the line-of-sight detection by the first line-of-sight detecting unit. The third duration calculating unit 14 may calculate the third duration using a result of the line-of-sight detection by the second line-of-sight detecting unit.

The utterer determining unit 31 may determine whether the utterer of input voice is a driver or a passenger on the front passenger seat by executing image recognition processing on an image captured by the camera 9. For example, the utterer determining unit 31 detects the mouth opening degree of a driver and the mouth opening degree of a passenger on the front passenger seat by executing image recognition processing on a captured image at a timing when voice is input to the first operation input device 6. The utterer determining unit 31 determines whether the utterer of the input voice is the driver or the passenger on the front passenger seat on the basis of the detected mouth opening degree.

A pressure sensor (so-called “seating sensor”) may be disposed on a seat surface of each of seats of the vehicle 1. In this case, the utterer determining unit 31 may determine whether the utterer of input voice is a driver or a passenger on the front passenger seat using detection values of these seating sensors. For example, the utterer determining unit 31 determines whether or not a passenger is seated on a the front passenger seat using detection values of the seating sensors disposed on a seat surface of the front passenger seat. When it is determined that no passenger is seated on the front passenger seat, the utterer determining unit 31 determines that the utterer of the input voice is the driver.

That is, the utterer determining unit 31 only needs to determine whether the utterer of input voice is a driver or a passenger on the front passenger seat using at least one of a result of voice signal processing on output signals from a plurality of microphones, a result of image recognition processing on an image captured by the camera 9, and values detected by the seating sensors.

Instead of determining whether or not the third duration has exceeded the third reference time, the operation completion determining unit 61 may determine whether or not the operation of the in-vehicle information device 2 by a passenger on the front passenger seat has been completed by determining whether or not a duration during which no input by the first operation input device 6 or no input by the second operation input device 7 is made (hereinafter, referred to as “fourth duration”) has exceeded a predetermined time (hereinafter, referred to as “fourth reference time”).

Instead of or in addition to the control for selectively setting the restriction on manual operation input to a valid state or an invalid state as described above, the operation restriction control device 100 may execute control for selectively setting restriction on screen display in the in-vehicle information device 2 (that is, screen display by display device 4) to a valid state or an invalid state.

Specifically, for example, the operation restriction control device 100 may execute control for selectively setting restriction on screen display by a video reproducing function to a valid state or an invalid state. That is, the first operation restriction control unit 22 may set the restriction on screen display by the video reproducing function to a valid state in step ST2. The second operation restriction control unit 33 may set the restriction on screen display by the video reproducing function to an invalid state in step ST13. The third operation restriction control unit 42 may set the restriction on screen display by the video reproducing function to a valid state in step ST22. The fourth operation restriction control unit 52 may set the restriction on screen display by the video reproducing function to an invalid state in step ST32. The fifth operation restriction control unit 62 may set the restriction on the screen display by the video reproducing function to a valid state in step ST42. The sixth operation restriction control unit 72 may set the restriction on screen display by the video reproducing function to a valid state in step ST52.

Usually, an act of viewing a video displayed on a screen by the video reproducing function does not involve manual operation input. For this reason, the configuration using a detection result of a hand approaching direction as described above can be applied to control for selectively setting the restriction on manual operation input to a valid state or an invalid state, but cannot be applied to control for selectively setting the restriction on screen display by the video reproducing function to a valid state or an invalid state.

Meanwhile, the operation restriction control device 100 according to the first embodiment uses a result of line-of-sight detection by the line-of-sight detecting unit 11 as described above. For this reason, of course, the operation restriction control device 100 can be applied to control for selectively setting the restriction on manual operation input to a valid state or an invalid state, and can also be applied to control for selectively setting the restriction on screen display by the video reproducing function to a valid state or an invalid state.

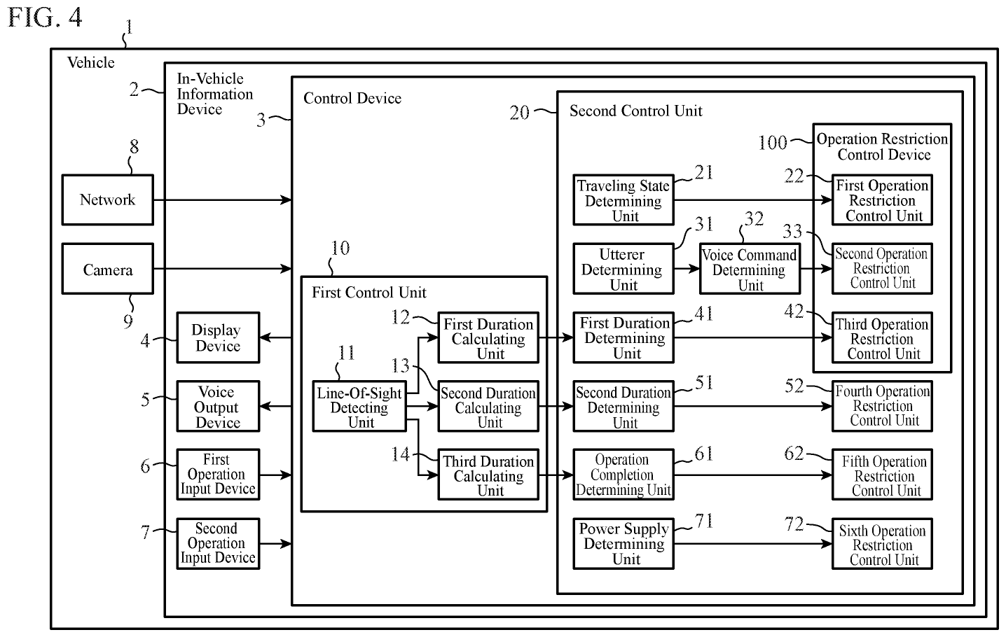

As illustrated in FIG. 4, even if a main part of the operation restriction control device 100 may be constituted by the first operation restriction control unit 22, the second operation restriction control unit 33, and the third operation restriction control unit 42. That is, the fourth operation restriction control unit 52, the fifth operation restriction control unit 62, and the sixth operation restriction control unit 72 may be arranged in the operation restriction control device 100 as illustrated in FIG. 1, or may be arranged outside the operation restriction control device 100 as illustrated in FIG. 4.

As described above, the operation restriction control device 100 according to the first embodiment is the operation restriction control device 100 for the in-vehicle information device 2 operable by the first operation input device 6 for receiving voice operation input and the second operation input device 7 for receiving manual operation input, and includes: the first operation restriction control unit 22 for setting restriction on manual operation input to a valid state in a case where the vehicle 1 is traveling; the second operation restriction control unit 33 for setting the restriction on manual operation input to an invalid state when a voice command corresponding to release of the restriction on manual operation input (restriction release command) is input to the first operation input device 6 by a passenger in the vehicle 1 (passenger on the front passenger seat) in a state where the first operation restriction control unit 22 sets the restriction on manual operation input to a valid state; and the third operation restriction control unit 42 for setting the restriction on manual operation input to a valid state when a duration during which the line of sight of a driver of the vehicle 1 is directed to the in-vehicle information device 2 (first duration) has exceeded the first reference time in a state where the second operation restriction control unit 33 sets the restriction on manual operation input to an invalid state. As a result, when a driver is manually operating (or about to operate) the in-vehicle information device 2, the restriction on manual operation input can be switched from an invalid state to a valid state. As a result, it is possible to suppress manual operation input by a driver.

The operation restriction control device 100 further includes the fourth operation restriction control unit 52 for setting restriction on manual operation input to an invalid state when a duration during which the line of sight of a driver is not directed to the in-vehicle information device 2 (second duration) has exceeded the second reference time in a state where the third operation restriction control unit 42 sets the restriction on manual operation input to a valid state. As a result, when a driver has stopped (or given up) manual operation of the in-vehicle information device 2, the restriction on manual operation input can be switched from a valid state to an invalid state. As a result, operability of the in-vehicle information device 2 by a passenger on the front passenger seat can be improved.

The operation restriction control device 100 further includes the fifth operation restriction control unit 62 for setting restriction on manual operation input to a valid state when operation of the in-vehicle information device 2 by a passenger (passenger on the front passenger seat) has been completed in a state where the second operation restriction control unit 33 or the fourth operation restriction control unit 52 sets the restriction on manual operation input to an invalid state. As a result, when the operation of the in-vehicle information device 2 by a passenger on the front passenger seat has been completed, the restriction on manual operation input can be switched from an invalid state to a valid state. At this time, a restriction release command can be discarded.

When a duration during which the line of sight of a passenger (passenger on the front passenger seat) is not directed to the in-vehicle information device 2 (third duration) has exceeded the third reference time, it is determined that the operation of the in-vehicle information device 2 by the passenger (passenger on the front passenger seat) has been completed. As a result, it is possible to determine a timing when the operation of the in-vehicle information device 2 by the passenger on the front passenger seat has been completed using a result of line-of-sight detection by the line-of-sight detecting unit 11.

The operation restriction control device 100 further includes the sixth operation restriction control unit 72 for setting restriction on manual operation input to a valid state when an accessory power supply (ACC power supply) in the vehicle 1 has been turned off in a state where the second operation restriction control unit 33 or the fourth operation restriction control unit 52 sets the restriction on manual operation input to an invalid state. As a result, when the ACC power supply has been turned off, the restriction on manual operation input can be switched from an invalid state to a valid state. At this time, a restriction release command can be discarded.

In addition to the control for selectively setting the restriction on manual operation input to a valid state or an invalid state, the operation restriction control device 100 executes control for selectively setting restriction on screen display in the in-vehicle information device 2 to a valid state or an invalid state. By using a result of the line-of-sight detection by the line-of-sight detecting unit 11, the operation restriction control device 100 can be applied to control for selectively setting the restriction on screen display by the video reproducing function to a valid state or an invalid state.

An operation restriction control method according to the first embodiment is an operation restriction control method for the in-vehicle information device 2 operable by the first operation input device 6 for receiving voice operation input and the second operation input device 7 for receiving manual operation input, and includes: step ST2 in which the first operation restriction control unit 22 sets restriction on manual operation input to a valid state in a case where the vehicle 1 is traveling; step ST13 in which the second operation restriction control unit 33 sets the restriction on manual operation input to an invalid state when a voice command corresponding to release of the restriction on manual operation input (restriction release command) is input to the first operation input device 6 by a passenger in the vehicle 1 (passenger on the front passenger seat) in a state where the first operation restriction control unit 22 sets the restriction on manual operation input to a valid state; and step ST22 in which the third operation restriction control unit 42 sets the restriction on manual operation input to a valid state when a duration during which the line of sight of a driver of the vehicle 1 is directed to the in-vehicle information device 2 (first duration) has exceeded the first reference time in a state where the second operation restriction control unit 33 sets the restriction on manual operation input to an invalid state. As a result, a similar effect to the above effect by the operation restriction control device 100 can be obtained.

Note that any component in the embodiment can be modified, or any component in the embodiment can be omitted within the scope of the present invention.

### INDUSTRIAL APPLICABILITY

The operation restriction control device of the present invention can be used for an in-vehicle information device.

### REFERENCE SIGNS LIST

1: Vehicle, 2: In-vehicle information device, 3: Control device, 4: Display device, 5: Voice output device, 6: First operation input device, 7: Second operation input device, 8: Network, 9: Camera, 10: First control unit, 11: Line-of-sight detecting unit, 12: First duration calculating unit, 13: Second duration calculating unit, 14: Third duration calculating unit, 20: Second control unit, 21: Traveling state determining unit, 22: First operation restriction control unit, 31: Utterer determining unit, 32: Voice command determining unit, 33: Second operation restriction control unit, 41: First duration determining unit, 42: Third operation restriction control unit, 51: Second duration determining unit, 52: Fourth operation restriction control unit, 61: Operation completion determining unit, 62: Fifth operation restriction control unit, 71: Power supply determining unit, 72: Sixth operation restriction control unit, 81: Processor, 82: Memory, 83: Processing circuit, 100: Operation restriction control device

1. An operation restriction control device for an in-vehicle information device operable by a first operation input device for receiving voice operation input and a second operation input device for receiving manual operation input, comprising:
processing circuitry configured to
set restriction on the manual operation input to a valid state in a case where a vehicle is traveling;
the restriction on the manual operation input to an invalid state when a voice command corresponding to release of the restriction on the manual operation input is input to the first operation input device by a passenger in the vehicle in a state where the restriction on the manual operation input is set to a valid state; and
set the restriction on the manual operation input to a valid state when a duration during which a line of sight of a driver of the vehicle is directed to the in-vehicle information device has exceeded a first reference time in a state where the restriction on the manual operation input is set to an invalid state.

2. The operation restriction control device according to claim 1,
wherein the processing circuitry is further configured to set the restriction on the manual operation input to an invalid state when a duration during which the line of sight of the driver is not directed to the in-vehicle information device has exceeded a second reference time in a state where the restriction on the manual operation input is set to a valid state.

3. The operation restriction control device according to claim 2,
wherein the processing circuitry is further configured to set the restriction on the manual operation input to a valid state when operation of the in-vehicle information device by the passenger has been completed in a state where the restriction on the manual operation input is set to an invalid state.

4. The operation restriction control device according to claim 3, wherein it is determined that the operation of the in-vehicle information device by the passenger has been completed when a duration during which the line of sight of the passenger is not directed to the in-vehicle information device has exceeded a third reference time.

5. The operation restriction control device according to claim 2,
wherein the processing circuitry is further configured to set the restriction on the manual operation input to a valid state when an accessory power supply in the vehicle has been turned off in a state where the restriction on the manual operation input is set to an invalid state.

6. The operation restriction control device according to claim 1, wherein execution of control for selectively setting restriction on screen display in the in-vehicle information device to a valid state or an invalid state is performed, in addition to control for selectively setting the restriction on the manual operation input to a valid state or an invalid state.

7. The operation restriction control device according to claim 2, wherein execution of control for selectively setting restriction on screen display in the in-vehicle information device to a valid state or an invalid state is performed, in addition to control for selectively setting the restriction on the manual operation input to a valid state or an invalid state.

8. The operation restriction control device according to claim 3, wherein execution of control for selectively setting restriction on screen display in the in-vehicle information device to a valid state or an invalid state is performed, in addition to control for selectively setting the restriction on the manual operation input to a valid state or an invalid state.

9. The operation restriction control device according to claim 4, wherein execution of control for selectively setting restriction on screen display in the in-vehicle information device to a valid state or an invalid state is performed, in addition to control for selectively setting the restriction on the manual operation input to a valid state or an invalid state.

10. The operation restriction control device according to claim 5, wherein execution of control for selectively setting restriction on screen display in the in-vehicle information device to a valid state or an invalid state is performed, in addition to control for selectively setting the restriction on the manual operation input to a valid state or an invalid state.

11. An operation restriction control method for an in-vehicle information device operable by a first operation input device for receiving voice operation input and a second operation input device for receiving manual operation input, comprising:
setting restriction on the manual operation input to a valid state in a case where a vehicle is traveling;
setting the restriction on the manual operation input to an invalid state when a voice command corresponding to release of the restriction on the manual operation input is input to the first operation input device by a passenger in the vehicle in a state where the restriction on the manual operation input is set to a valid state; and
setting the restriction on the manual operation input to a valid state when a duration during which a line of sight of a driver of the vehicle is directed to the in-vehicle information device has exceeded a first reference time in a state where the restriction on the manual operation input is set to an invalid state.
